(19) United States
(12) Patent Application Publication
(10) Pub. No.: US 2015/0217614 A1
(43) Pub. Date: Aug. 6, 2015

(54) BALL JOINT

(71) Applicant: NITTA CORPORATION, Osaka-shi, Osaka (JP)

(72) Inventor: Yasuhiro Aoki, Yamatokoriyama-shi (JP)

(21) Appl. No.: 14/420,838

(22) PCT Filed: Jul. 2, 2013
(86) PCT No.: PCT/JP2013/068122

§ 371 Date: Feb. 10, 2015

(30) Foreign Application Priority Data
Aug. 10, 2012 (JP) 2012-178852

(51) Int. Cl. B60G 7/00; B25J 17/00

(52) U.S. Cl. CPC B60G 7/005; B25J 17/00

(57) ABSTRACT

The sliding characteristic of a ball portion is improved, the durability of a ball sheet is improved, and an impact on the ball portion is absorbed. A ball joint includes a ball stud and a supporting body housed in a housing. Between a ball portion and the supporting body, a ball sheet is provided. The ball sheet is constituted by fabric impregnated with rubber or resin.

### TECHNICAL FIELD

The present invention relates to a ball joint used for a suspension of a vehicle and an arm of a robot.

### BACKGROUND

A known ball joint includes a ball stud having a ball portion, a socket (housing), and a ball sheet housed in the socket, and the ball portion is rotatably and slidably supported by the ball sheet (see, e.g., Patent Literatures 1 to 3).

### CITATION LIST

### Patent Literatures

[Patent Literature 1] Japanese Patent No. 4863638
[Patent Literature 2] Japanese Unexamined Patent Publication No. 2012-021600
[Patent Literature 3] Japanese Unexamined Patent Publication No. 2012-17751

### SUMMARY OF INVENTION

### Technical Problem

The ball sheet does not excel in sliding characteristic and abrasion characteristic because it is typically made of resin. For this reason, in the known ball joint (recited in documents such as Patent Literatures 1 to 3), the ball portion does not smoothly rotate and slide on the ball sheet, and the durability is low because of large abrasion loss of the ball sheet. Furthermore, because the resin above is relatively hard, an impact on the ball portion is not absorbed. According to a known arrangement, the improvement in the sliding characteristic of the ball portion is achieved by providing a gap between the ball portion and the ball sheet. This arrangement, however, is disadvantageous in that vibration sound is generated by a rattle which occurs due to the presence of the gap, and the ball sheet is abnormally worn.

An object of the present invention is to provide a ball joint in which a ball portion excels in sliding characteristic, the durability is high, and impact on the ball portion is absorbed.

### Solution to Problem

A ball joint of the present invention includes: a ball stud including a ball portion and a shaft portion which radially protrudes from an outer peripheral surface of the ball portion; a supporting body supporting the ball portion; and an outer peripheral member provided along the outer peripheral surface of the ball portion and between the ball portion and the supporting body to allow the ball portion to be able to rotate and slide, the outer peripheral member being constituted by fabric impregnated with rubber or resin.

According to the present invention, the sliding characteristic of the ball portion is improved by providing the fabric (outer peripheral member) between the ball portion and the supporting body. Furthermore, because no gap is formed between the ball portion and the outer peripheral member as the fabric (outer peripheral member) is provided along the outer peripheral surface of the ball portion, the occurrence of rattling is prevented. Furthermore, because the outer peripheral member is impregnated with the rubber or resin, the outer peripheral member excels in abrasion resistance and shock absorption, and hence the ball joint which excels in durability is obtained.

In addition to the above, preferably, the ball joint above further include a cylindrical cover member entirely covering a base end portion of the shaft portion, an end of the cover member being fixed to the shaft portion, and the cover member being formed to be integrated with the outer peripheral member.

According to the arrangement above, because the cover member is formed to be integrated with the outer peripheral member, foreign matters may enter the cover member only from the fixed portion of the cover member where the cover member is fixed to the shaft portion. This decreases the rate of entrance of foreign matters into the cover member. Furthermore, the number of steps for constructing the ball joint is reduced.

In addition to the above, the ball joint above is preferably arranged such that the fabric extends in the cover member. Because the cover member is pulled or compressed in the direction in which the shaft portion is inclined due to the rotation and sliding of the ball portion, the cover member is easily cracked and damaged. In this regard, because the fabric (outer peripheral member) which is not easily damaged is provided to extend in the cover member, the damage of the cover member is restrained even if the ball portion rotates and slides. Furthermore, when the fabric extends in the cover member, the cover member is less likely to be damaged, e.g., cracked when a foreign matter collides therewith, as compared to a cover member made of rubber. Furthermore, even if a crack or the like is formed, such a crack is less likely to develop.

In addition to the above, the outer peripheral member preferably includes solid lubricant. When the outer peripheral member includes solid lubricant, the sliding characteristic of the ball portion is improved, and hence the ball portion is able to smoothly rotate and slide.

In addition to the above, in the present invention the supporting body is preferably made of a material having a smaller elastic modulus than a material of which the outer peripheral member is made. As the supporting body and the outer peripheral member have different moduluses (hardness) and the supporting body is arranged to be softer than the outer peripheral member, an impact on the ball joint from the outside is absorbed by the supporting body, and hence an influence on the rotation and sliding of the ball portion is effectively reduced and transfer of vibrations to the machine main body is restrained.

### Advantageous Effects of Invention

When the ball joint of the present invention is employed, the sliding characteristic of the ball portion is improved as the fabric (outer peripheral member) is provided between the ball portion and the supporting body. Furthermore, because no gap is formed between the ball portion and the outer peripheral member as the fabric (outer peripheral member) is provided along the outer peripheral surface of the ball portion, the occurrence of rattling is prevented. Furthermore, because the outer peripheral member is impregnated with the rubber or resin, the outer peripheral member excels in abrasion resistance and shock absorption, and hence the ball joint which excels in durability is obtained.

### BRIEF DESCRIPTION OF DRAWINGS

FIG. 1 is a cross section of a ball joint of First Embodiment of the present invention.

FIG. 2A is a cross section showing a step of constructing the ball joint.

FIG. 2B is a cross section showing a step of constructing the ball joint.

FIG. 2C is a cross section showing a step of constructing the ball joint.

FIG. 2D is a cross section showing a step of constructing the ball joint.

FIG. 3 is a cross section of a ball joint of Second Embodiment of the present invention.

FIG. 4 is a cross section of a ball joint of Third Embodiment of the present invention.

### DESCRIPTION OF EMBODIMENTS

The following will describe embodiments of the present invention.

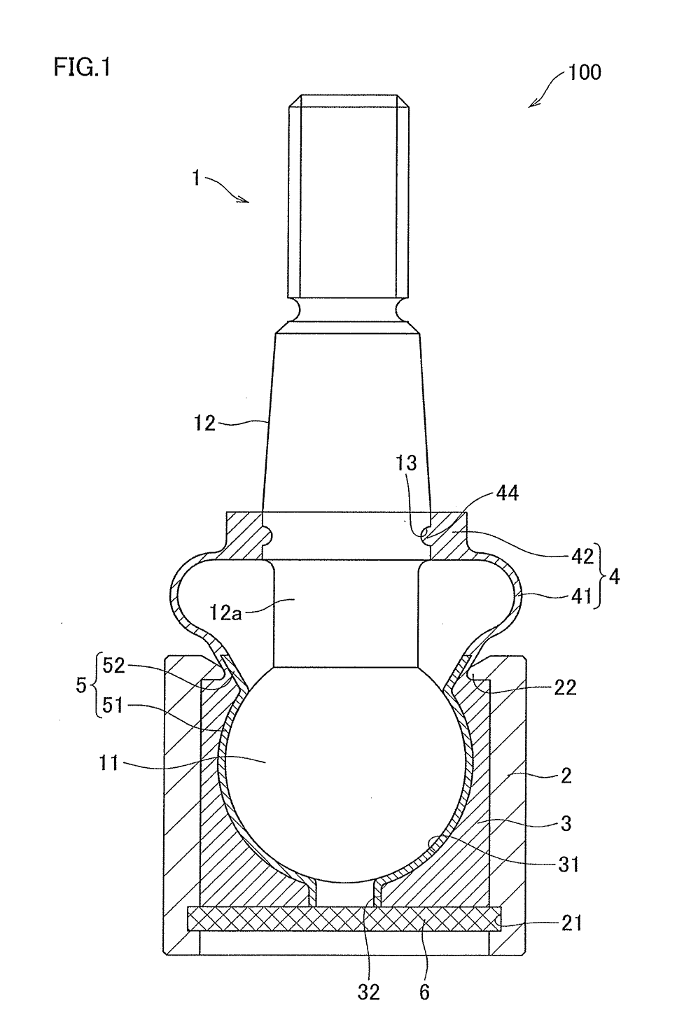

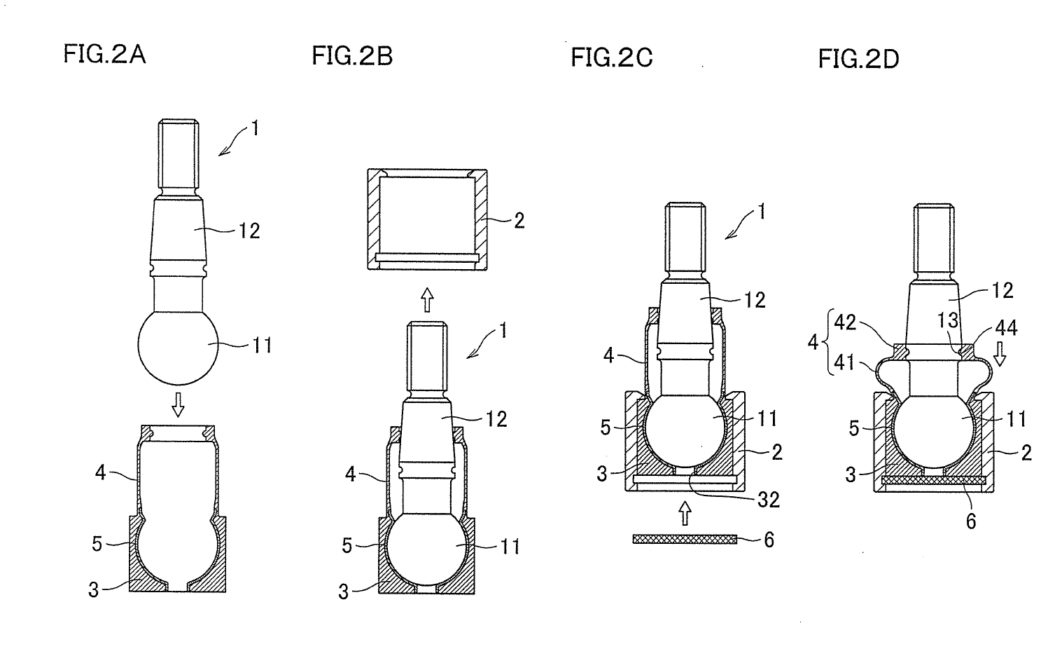

To begin with, a ball joint 100 which is First Embodiment of the present invention will be described with reference to FIGS. 1 and 2.

[Ball Joint]

As shown in FIG. 1, the ball joint 100 includes a ball stud 1, a substantially cylindrical housing 2, a supporting body 3 housed in the housing 2, and a dust cover (cover member) 4.

(Ball Stud)

The ball stud 1 is made of a metal material and includes a ball portion 11 housed in the housing 2 and a shaft portion 12 which radially protrudes from the outer peripheral surface of the ball portion 11. The ball portion 11 is supported by the supporting body 3, and a ball sheet (outer peripheral member) 5 is provided between the ball portion 11 and the supporting body 3. The ball sheet 5 is provided along the outer peripheral surface of the ball portion 11, and an upper part of the ball sheet 5 extends in the dust cover 4 so as to be integrated with the dust cover 4. The supporting body 3, the dust cover 4, and the ball sheet 5 are integrally molded. The details of the ball sheet 5 will be given later.

(Housing)

The housing 2 is a made of metal and is open at the top and the bottom, and the bottom opening is closed by a cap 6. The cap 6 is engaged with a groove 21 formed in the inner wall surface of a lower end portion of the housing 2. At an upper end portion of the housing 2, an edge portion 22 is formed to protrude toward the internal space, in order to prevent the supporting body 3 from dropping out from the housing 2 to the outside.

(Supporting Body)

The supporting body 3 is made of an elastic material such as synthetic resin and rubber, but the elastic modulus thereof is lower than that of the ball sheet 5. On this account, the supporting body 3 is softer than the ball sheet 5. In the supporting body 3, a substantially spherical concave portion 31 in which the ball portion 11 can be fitted and a hole 32 which extends downward from the lower end face of the concave portion 31 are formed. The hole 32 functions as a space into which the supporting body 3 extends when the supporting body 3 is pressed from below by the cap 6. The supporting body 3 is integrated with the dust cover 4.

(Dust Cover)

The dust cover 4 is a cylindrical member that covers the entire circumference of a base end portion 12a of the shaft portion 12 of the ball stud 1, and is made of an elastic material such as synthetic resin and rubber, which is identical with the material of the supporting body 3. The dust cover 4 includes a swelling portion 41 which radially swells from the edge portion 22 of the housing 2 and a fixed portion 42 which is above the swelling portion 41 and is fixed to the shaft portion 12, and the dust cover 4 does not contact with the ball stud 1. While the swelling portion 41 does not contact with the shaft portion 12, the fixed portion 42 contacts with the shaft portion 12. Inside a lower end portion of the swelling portion 41, the ball sheet 5 is provided to be as high as the upper end of the housing 2. The swelling portion 41 is pulled or compressed in the direction in which the shaft portion 12 is inclined, in accordance with the rotation and sliding of the ball portion 11.

The fixed portion 42 is a substantially annular in shape and smaller in diameter than the swelling portion 41, and the shaft portion 12 is inserted in the fixed portion 42. The fixed portion 42 is thicker than the swelling portion 41, and the vertical cross section (of one of the symmetrical sides about the center) is rectangular such that the vertical length (height) is longer than the horizontal length (width). On the inner peripheral surface of the fixed portion 42, a convex portion 44 is formed to protrude radially inward, and the fixed portion 42 is fixed to the shaft portion 12 as the convex portion 44 is fitted into the concave portion 13 of the shaft portion 12.

(Ball Sheet)

The ball sheet 5 includes a contact portion 51 provided to contact with the outer peripheral surface of the ball portion 11 and an extending portion 52 which extends from the contact portion 51 away from the ball portion 11, and the ball sheet 5 rotatably and slidably supports the ball portion 11. The contact portion 51 contacts with the ball portion 11 of the ball sheet 5 but the extending portion 52 does not contact with the ball sheet 5. At the bottom part of the ball sheet 5 is formed a hole, and the ball sheet 5 extends downward from an edge portion of the hole.

The ball sheet 5 is made of fabric impregnated with rubber or resin. Because the ball sheet 5 is mainly made of the fabric, the sliding characteristic of the ball portion 11 is better than that of a sheet made of rubber or the like, and no gap is formed between the ball sheet 5 and the ball portion 11. Furthermore, because the fabric is impregnated with rubber or resin, the abrasion resistance and shock absorption are good as compared to a sheet made solely of fabric, and the property of adhesion to the supporting body 3 and the ball portion 11 is good.

<Fabric>

The fabric of which the ball sheet 5 is made is, for example, formed by fibers (yarns) made of a typical material. The fabric is, for example, formed by weaving or knitting fibers made of a material such as aramid, nylon, urethane, cotton, silk, hemp, acetate, rayon, and fluorine, fibers (yarns) made of polyester or the like, or a combination of them. Furthermore, fabric such as non-woven fabric formed by entangling fibers (yarns) may be used. In the present embodiment, such fabric is formed into a sheet. To restrain friction between the fibers (yarns), the surface of each fiber (yarn) may be coated with silicon, Teflon (registered trademark), oil, or the like.

The outer peripheral surface of the ball portion 11 and the inner peripheral surface of the supporting body 3 are substantially spherical curved surfaces, and the ball sheet 5 is provided between these curved surfaces, along the outer peripheral surface of the ball portion 11. The ball portion 11 slides on the curved supporting body 3. For this reason, when the ball sheet 5 is, for example, creased, the crease resists the sliding of the ball portion 11, and hence the sliding resistance may increase at the crease, or abnormal wear may occur. To prevent the generation of crease or the like on the ball sheet 5, flexible fabric is preferably used. With such fabric, when the ball sheet 5 is provided on the curved surface (sliding surface) of the supporting body 3, the generation of crease or the like in the ball sheet 5 is prevented in such a way that the fabric is pasted onto the supporting body 3 or the ball portion 11 while the fabric is stretched along the curved surface of the supporting body 3 or the ball portion 11.

Because the fabric is formed by weaving, knitting, or entangling fibers (yarns), flexibility is imparted to the fabric by suitably weaving, knitting, or entangling fibers (yarns). In this regard, flexibility is typically imparted in such a way that yarns which are flexible (extensible) are used and fabric is made by (e.g., weaving) such yarns in a compressed state. The fabric formed in this manner is flexible in the directions in which the yarns extend and contract. In the meanwhile, because woven fabric is formed by alternately weaving weft yarns and warp yarns, flexibility is obtained when the weft yarns and warp yarns are flexible. For example, when the weft yarns are woolly-finished nylon yarns (hereinafter, woolly-finished yarns), woven fabric which is extensible in the lateral directions is obtained. When the warp yarns are also woolly-finished yarns, the woven fabric is extensible not only in the vertical and lateral directions but also in oblique directions. The flexible yarns are not limited to the woolly-finished yarns, and various types of yarns such as covered yarns may be employed.

<Rubber>

The rubber with which the fabric is impregnated is required to be able to permeate the fabric. Examples of the rubber include urethane rubber, nitrile rubber, silicon rubber, fluorine rubber, acryl rubber, ethylene-propylene rubber, butyl rubber, isoprene rubber, chlorinated polyethylene rubber, epichlorohydrin rubber, hydrogenated nitrile rubber, chloroprene rubber, polybutadiene rubber, styrene-butadiene rubber, natural rubber, or a denatured one of these types of rubber. Such rubber may be used independently or in combination. To the rubber, in addition to a vulcanizing agent, a suitable amount of a vulcanization accelerator, an age resister, a softener, a plasticizer, a filler, a colorant or the like, which have been used as additives for the rubber, may be added. In addition to them, to improve the smoothness of the fabric, a solid lubricant such as graphite, silicon oil, fluorine powder, molybdenum disulphide or the like may be included in the rubber.

<Resin>

Examples of the resin with which the fabric above is impregnated include thermoplastic resins such as acrylic resin, polyester resin, urethane resin, vinyl chloride resin, polypropylene, polycarbonate, PET resin, fluorine resin, polyethylene, AS resin, ABS resin, PEEK resin, polystyrene resin, polyvinyl chloride, polyvinylidene chloride, polyvinyl acetate, nylon, alkyd resin, phenol resin, epoxy resin, and polyphenylene sulfide resin, and thermosetting resins.

<Method of Causing Fabric to be Impregnated with Rubber or Resin>

To cause the fabric to be impregnated with the rubber or the resin, to begin with, the rubber or resin is dissolved in a solvent, and fabric is dipped into the obtained solution (dipping process). Thereafter, the fabric is taken out, a redundant solution is removed from the fabric, and the fabric is dried, with the result that the fabric used in the present invention is obtained. By causing the rubber or resin to be adhered to the fabric in this way, the abrasion resistance, shock absorption, and adhesion property of the ball sheet 5 are improved. When the amount of the adhered rubber or resin is too large, the abrasion resistance, shock absorption, and adhesion property are improved but the flexibility is deteriorated as the yarns are bound by the processing agent. On the other hand, when the amount of the adhered rubber or resin is too small, the flexibility is maintained to be identical with that before the processing but the obtained abrasion resistance, shock absorption, and adhesion property are not good. When the adhesion property is deteriorated, the ball sheet 5 tends to be disadvantageously peeled off from the ball portion 11 or the supporting body 3 during use. For the reasons above, the amount of the adhered rubber or resin is preferably 10 g/m² or larger and 100 g/m² or smaller. These amounts are mere examples, and the disclosure is not limited to them.

In addition to the above, fabric formed by causing fabric to be impregnated with the rubber or resin and coating one surface of the fabric with rubber is suitably employed. The adhesion property is improved by arranging the coated surface to be adhered to the supporting body 3 or the ball portion 11. Furthermore, because the elasticity of the fabric is improved on account of the coating with the rubber, the shock absorption is improved.

The ball sheet 5 may include a solid lubricant. Because the fabric constituting the ball sheet 5 and the rubber with which the fabric is impregnated include the solid lubricant, the lubricity of the ball sheet 5 is improved. Preferred examples of the solid lubricant include graphite, silicon oil, fluorine powder, and molybdenum disulfide.

As the ball sheet 5 produced as described above is provided between the ball portion 11 and the supporting body 3, the ball sheet 5 is adhered to the ball portion 11 and the supporting body 3 on account of the rubber or resin with which the ball sheet 5 is impregnated. In this regard, the adhesion property of the ball sheet 5 is further improved by using an adhesive. A typical adhesive may be used as the adhesive above. Examples of the adhesive include acrylic resin adhesive, olefin adhesive, urethane resin adhesive, ethylene-vinyl acetate resin adhesive, epoxy resin adhesive, vinyl chloride resin adhesive, chloroprene rubber adhesive, cyanoacrylate adhesive, silicon adhesive, styrene-butadiene rubber adhesive, nitrile rubber adhesive, hot melt adhesive, phenol resin adhesive, melamine resin adhesive, urea resin adhesive, and resorcinol adhesive. The adhesive is used in such a way that, for example, the adhesive is heated and melted to be fluid and applied to the ball sheet 5 (or the ball portion 11 or the supporting body 3) and then cooled and cured, or the adhesive is heated to be thermally set.

Now, how the ball joint 100 is constructed will be described with reference to FIGS. 2A-2D.

To begin with, as shown in FIG. 2A, a structure in which the ball sheet 5 is pasted onto the inner surface of the supporting body 3 and the supporting body 3, the dust cover 4, and the ball sheet 5 are integrally molded is prepared. In this regard, because the ball sheet 5 is pasted onto the supporting body 3 while being stretched along the curved surface of the supporting body 3, the surface of the ball sheet 5 is not creased. Alternatively, when the ball sheet 5 and the supporting body 3 are integrally molded, the molding may be performed after an adhesive is applied to the surface of the ball sheet 5. In the state shown in FIG. 2A, the dust cover 4 is substantially cylindrical in shape to extend in the axial direction, and is not radially bulged.

Subsequently, as the ball portion 11 of the ball stud 1 is fitted into the supporting body 3 and the ball portion 11 is pressed onto the ball sheet 5, the ball stud 1 is mounted in the supporting body 3. In the present embodiment, because the dust cover 4 and the ball sheet 5 are integrated, the shaft portion 12 of the ball stud 1 is inserted into the dust cover 4 as the ball portion 11 is fitted in the supporting body 3, with the result that the dust cover 4 is attached to the shaft portion 12 (see FIG. 2B). Because the supporting body 3 is made of an elastic material such as synthetic resin or rubber, the inlet at an upper part of the supporting body 3 is deformed when the ball portion 11 is fitted in the supporting body 3, and hence the ball portion 11 which is larger in shape than the inlet is successfully fitted into the supporting body 3.

Subsequently, as shown in FIG. 2B, the supporting body 3 in which the ball stud 1 is installed is housed in the housing 2 through the opening at the lower end of the housing 2.

Thereafter, as shown in FIG. 2C, while the supporting body 3 is pressed from below by the cap 6, the opening at the lower end portion of the housing 2 is closed. As the supporting body 3 is pressed from below, a part of the supporting body 3 protrudes into the hole 32 and the ball sheet 5 contacts with the outer peripheral surface of the ball portion 11, with the result that no gap is formed between the ball sheet 5 and the ball portion 11.

Lastly, as shown in FIG. 2D, the fixed portion 42 of the dust cover 4 is pressed down along the shaft portion 12, and the convex portion 44 of the fixed portion 42 is fitted into the concave portion 13 of the shaft portion 12, so that the fixed portion 42 is fixed to the shaft portion 12. As a result, the swelling portion 41 of the dust cover 4 radially swells.

As described above, in the ball joint 100 of the present embodiment, because the ball sheet 5 made of the fabric is provided between the ball portion 11 and the supporting body 3, the sliding characteristic of the ball portion 11 is good. Furthermore, because the ball sheet 5 is provided along the outer peripheral surface of the ball portion 11 so that no gap is formed between the ball sheet 5 and the ball portion 11, the occurrence of rattling is prevented. Furthermore, because the fabric of which the ball sheet 5 is made is impregnated with the rubber or resin, the ball sheet 5 excels in the abrasion resistance and shock absorption, and hence the ball joint 100 which excels in durability is obtained.

In addition to the above, because the dust cover 4 and the ball sheet 5 are integrally formed, foreign matters may enter the dust cover 4 only from a part at which the dust cover 4 contacts with the shaft portion 12 (i.e., at the fixed portion 42), and hence the rate of entrance of foreign matters into the dust cover 4 is restrained. Furthermore, when the ball joint 100 is constructed, the dust cover 4 is attached to the ball stud 1 in accordance with the installation of the ball stud 1 in the supporting body 3. For this reason, it is unnecessary to provide a step of attaching the dust cover 4 to the ball stud 1 in addition to a step of installing the ball stud 1 in the supporting body 3. As such, the number of steps for constructing the ball joint 100 is reduced.

In addition to the above, the fixed portion 42 of the dust cover 4 very closely contacts with the shaft portion 12 because the fixed portion 42 is made of the same synthetic resin, rubber or the like as the supporting body 3. This restrains the entrance of foreign matters through a gap between the fixed portion 42 and the shaft portion 12.

In addition to the above, because the ball sheet 5 includes solid lubricant, the sliding characteristic of the ball portion 11 is improved. The ball portion 11 therefore smoothly rotates and slides.

In addition to the above, because the supporting body 3 is made of a material having a lower elastic modulus than the material of the ball sheet 5, an impact on the ball joint from the outside is absorbed by the supporting body 3, and hence an influence on the rotation and sliding of the ball portion 11 is effectively reduced and transfer of vibrations to the machine main body is restrained.

### Second Embodiment

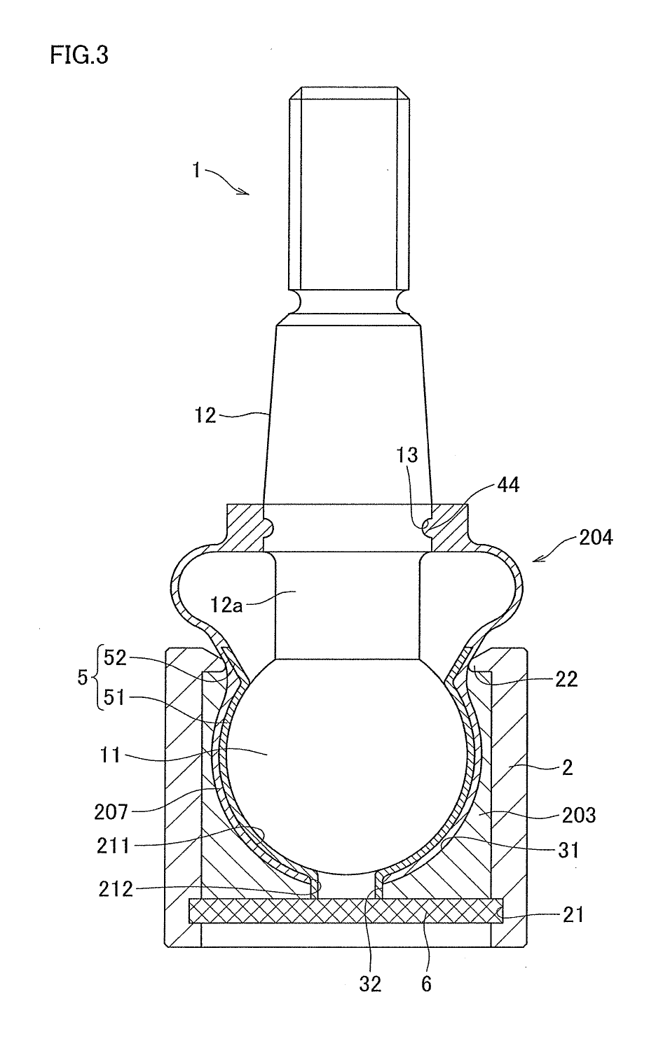

Now, Second Embodiment of the present invention will be described with reference to FIG. 3. Second Embodiment is different from First Embodiment in that a holding sheet 207 is provided between a supporting body 203 and a ball sheet 5. The members identical with those in First Embodiment above will be denoted by the same reference numerals and the explanations thereof are not repeated.

In the present embodiment, the supporting body 203 and a dust cover 204 are different members, and the dust cover 204 and the supporting body 203 may be made of different materials.

At the holding sheet 207 provided outside the ball sheet 5, a substantially spherical concave portion 211 in which the ball portion 11 can be fitted is formed, and a hole 212 is formed at a bottom portion of the concave portion 211. At the hole 212, a part of the ball sheet 5 which part is at the bottom portion of the ball sheet 5 and extends downward is provided. Furthermore, the holding sheet 207 entirely contacts with the ball sheet 5 until reaching the lower edge of the edge portion 22 of the housing 2, and the holding sheet 207 is integrated with the dust cover 204 provided above. The holding sheet 207 may be made of the same material as the dust cover 204, and may be made of a material different from the material of the supporting body 203 provided outside.

In addition to the above, the supporting body 203, the dust cover 204, the ball sheet 5, and the holding sheet 207 are integrally molded.

As described above, also in the present embodiment, the ball portion 11 excels in the sliding characteristic and the durability as in First Embodiment, and an impact on the ball portion 11 is absorbed by the supporting body 203, the holding sheet 207, and the ball sheet 5.

### Third Embodiment

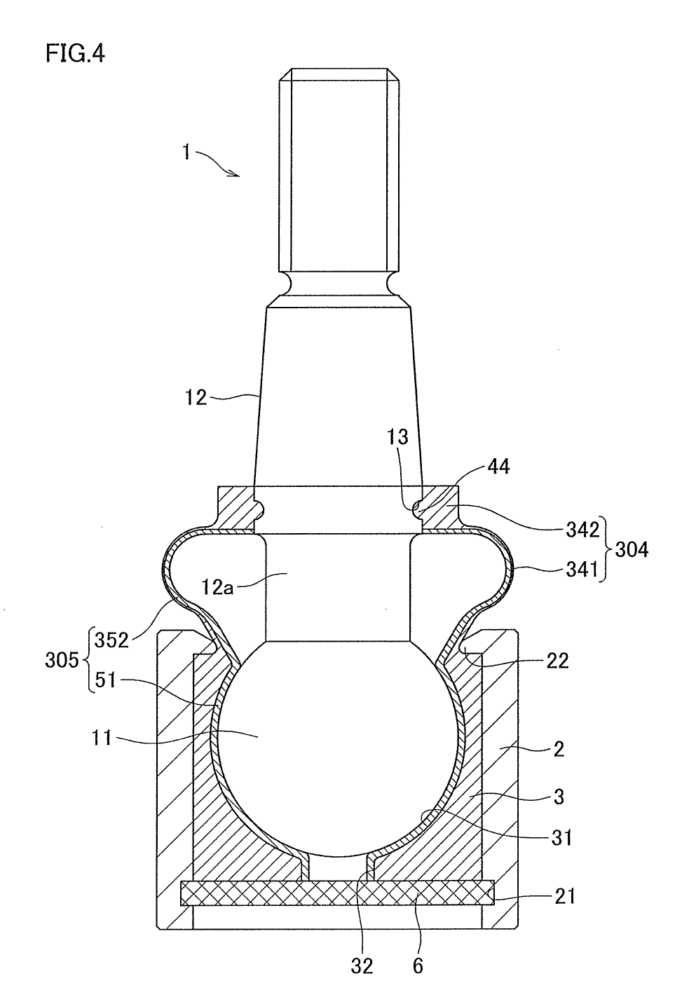

Now, Third Embodiment of the present invention will be described with reference to FIG. 4. Third Embodiment is different from First Embodiment in that a ball sheet 305 extends to reach a fixed portion 342 of a dust cover 304. The members identical with those in First Embodiment above will be denoted by the same reference numerals and the explanations thereof are not repeated.

The ball sheet 305 includes the contact portion 51 and an extending portion 352 which extends from the contact portion 51 to be away from the ball portion 11. The extending portion 352 extends to reach the swelling portion 341 of the dust cover 304 and a lower end portion of the fixed portion 342, and one end thereof extends to the vicinity of the shaft portion 12. The extending portion 352 does not contact with the ball portion 11.

The dust cover 304 is provided outside the extending portion 352 of the ball sheet 305 and is formed to be integrated with the ball sheet 305. As such, a part of the dust cover 304 which part swells radially outward has a two-layer structure constituted by the swelling portion 341 and the ball sheet 305 provided on the inner side thereof. The dust cover 304 is integrated with the supporting body 3 and made of the same material as the supporting body 3.

The supporting body 3, the dust cover 304, and the ball sheet 305 are integrally molded.

Also in the present embodiment, the ball portion 11 excels in the sliding characteristic and the durability as in First Embodiment, and an impact on the ball portion 11 is absorbed.

Furthermore, the part of the dust cover 304 swelling radially outward has the two-layer structure constituted by the swelling portion 341 and the ball sheet 305 provided on the inner side thereof, and the ball sheet 305 on the inner side is made of a material having a smaller elastic modulus than the material of the swelling portion 341 on the outer side. For this reason, the swelling portion 341 on the outer side is supported from the inner side by the ball sheet 305. With this arrangement, even if the swelling portion 41 is pulled or compressed in the direction in which the shaft portion 12 is inclined due to the rotation and sliding of the ball portion 11, the swelling portion 41 is likely to recover the original shape. Furthermore, thanks to the two-layer structure, the swelling portion 341 is less likely to be damaged, e.g., cracked when a foreign matter collides therewith, as compared to a cover member made solely of rubber. Furthermore, even if a crack or the like is formed, such a crack is less likely to develop.

While the embodiments of the present invention have been described based on the figures, the scope of the invention is not limited to the above-described embodiments. The scope of the present invention is defined by the appended claims rather than the foregoing description of the embodiments, and various changes and modifications can be made herein without departing from the scope of the invention.

For example, while in the embodiments above the dust cover 4 (204, 304) is formed to be integrated with the ball sheet 5 (305), the dust cover may not be integrated with the ball sheet and these members may be independent from each other.

While in the embodiments above the supporting body 3 (203) and the ball sheet 5 (305) are different members, the supporting body may be formed to be integrated with the ball sheet. The number of steps for constructing the ball joint is further reduced in this case.

In addition to the above, a position on the dust cover 4 (204, 304) where the ball sheet 5 (305) reaches the dust cover is, as described in the embodiments, not limited to the lower end portion of the swelling portion 41 or the lower end portion of the extending portion 352. The ball sheet 5 (305) may extend to reach the vicinity of the center of the swelling portion, or the border between the swelling portion and the fixed portion. Alternatively, the ball sheet may not extend in the dust cover.

In addition to the above, in the embodiments above, the ball sheet 5 (305) may or may not include the solid lubricant.

While in the embodiments above the supporting body 3 (203) is made of the material having a lower elastic modulus than the material of the ball sheet 5 (305), the supporting body may be made of a material having an elastic modulus similar to that of the material of the ball sheet, or made of a material having an elastic modulus higher than that of the material of the ball sheet.

In addition to the above, while in the embodiments above a hole is formed at the bottom portion of the ball sheet 5 (305), no hole may be formed.

In addition to the above, the method of constructing the ball joint 100 may not be performed in the order described in the embodiments above.

### REFERENCE SIGNS LIST

1 BALL STUD
2 HOUSING
3, 203 SUPPORTING BODY
4, 204, 304 DUST COVER (COVER MEMBER)
5, 305 BALL SHEET (OUTER PERIPHERAL MEMBER)
11 BALL PORTION
12 SHAFT PORTION
31, 211 CONCAVE PORTION
32, 212 HOLE
41, 342 FIXED PORTION
42, 341 SWELLING PORTION
100 BALL JOINT
207 HOLDING SHEET

1. A ball joint comprising:
a ball stud including a ball portion and a shaft portion which radially protrudes from an outer peripheral surface of the ball portion;
a supporting body supporting the ball portion; and
an outer peripheral member provided along the outer peripheral surface of the ball portion and between the ball portion and the supporting body to allow the ball portion to be able to rotate and slide,
the outer peripheral member being constituted by fabric impregnated with rubber or resin.

2. The ball joint according to claim 1, further comprising
a cylindrical cover member entirely covering a base end portion of the shaft portion,
an end of the cover member being fixed to the shaft portion, and
the cover member being formed to be integrated with the outer peripheral member.

3. The ball joint according to claim 2, wherein,
the fabric extends in the cover member.

4. The ball joint according to claim 1, wherein,
the outer peripheral member includes solid lubricant.

5. The ball joint according to claim 2, wherein,
the outer peripheral member includes solid lubricant.

6. The ball joint according to claim 3, wherein,
the outer peripheral member includes solid lubricant.

7. The ball joint according to claim 1, wherein,
the supporting body is made of a material having a smaller elastic modulus than a material of which the outer peripheral member is made.

8. The ball joint according to claim 2, wherein,
the supporting body is made of a material having a smaller elastic modulus than a material of which the outer peripheral member is made.

9. The ball joint according to claim 3, wherein,
the supporting body is made of a material having a smaller elastic modulus than a material of which the outer peripheral member is made.

10. The ball joint according to claim 4, wherein,
the supporting body is made of a material having a smaller elastic modulus than a material of which the outer peripheral member is made.

11. The ball joint according to claim 5, wherein,
the supporting body is made of a material having a smaller elastic modulus than a material of which the outer peripheral member is made.

12. The ball joint according to claim 6, wherein,
the supporting body is made of a material having a smaller elastic modulus than a material of which the outer peripheral member is made.
